(19) United States
(12) Patent Application Publication
(10) Pub. No.: US 2010/0047470 A1
(43) Pub. Date: Feb. 25, 2010

(54) Method for producing a three-dimensionally shaped object

(75) Inventors: Satoshi Abe, Moriguchi-shi (JP); Norio Yoshida, Kitakatsuragi-gun (JP); Isao Fuwa, Osaka-shi (JP); Masataka Takenami, Kadoma-shi (JP)

Correspondence Address: BACON & THOMAS, PLLC, 625 SLATERS LANE, FOURTH FLOOR, ALEXANDRIA, VA, 22314-1176, US

(73) Assignee: Panasonic Electric Works Co., Ltd., Osaka (JP)

(21) Appl. No.: 12/461,600

(22) Filed: Aug. 18, 2009

(30) Foreign Application Priority Data
Aug. 25, 2008 (JP) 2008-215219

(51) Int. Cl. B05D 3/00

(52) U.S. Cl. 427/553

(57) ABSTRACT

A method for producing a three-dimensionally shaped object, includes a powder layer forming step of supplying a powdery material to form a powder layer; a solidified layer forming step of irradiating a light beam on a specified portion of the powder layer to sinter or melt the powder layer into a solidified layer; and a step of repeating the powder layer forming step and the solidified layer forming step to integrally laminate the solidified layer to produce the three-dimensionally shaped object. The solidified layer is integrally formed on an upper surface of a substrate and the thickness of the substrate is decided by a maximum horizontal cross-sectional area of the shaped object. The substrate is made of a material having the Young's modulus greater than that of the shaped object.

### FIELD OF THE INVENTION

The present invention relates to a method for producing a three-dimensionally shaped object by irradiating a light beam on a specified portion of a powdery material and sinter or melt the same.

### BACKGROUND OF THE INVENTION

Conventionally, there is known a method for producing a three-dimensionally shaped object (hereinafter simply referred to as a shaped object) by repeating a step of forming a powder layer and a step of irradiating a light beam on a specified portion of the powder layer to sinter or melt the same into a solidified layer (see, e.g., Japanese Patent No. 2620353).

In the production method as noted above, a powdery material is supplied on a substrate and leveled by a blade to form a powder layer. After the powder layer has been solidified, the substrate is moved down by a distance equivalent to the thickness of a single solidified layer. Then a new powder layer is formed on the solidified layer (see, e.g., Japanese Patent Laid-open Publication No. 8-281807). With this method, the lowermost powder layer is fixedly secured to the substrate in the sintering and solidifying process, whereby the shaped object and the substrate are formed into a single body.

Shown in FIG. 12 is a warpage phenomenon that may occur when producing a shaped object in the afore-mentioned manner. In the course of producing a shaped object 10, volumetric contraction is generated in a powder layer 11 as the latter is sintered and solidified by the irradiation of a light beam L. Thus, the powder layer 11 tends to contract in the plane direction thereof. Due to the stress caused by this contraction, a moment for causing the shaped object 10 to be warped upwards acts in the shaped object 10 whereby the shaped object 10 undergoes warpage. If a substrate 12 is too thin to have great enough rigidity, the substrate 12 is also warped together with the shaped object 10.

It may be thought that, if the substrate 12 is thickened so as to enjoy great enough rigidity, it would become possible to restrain the shaped object 10 from being warped and eventually to produce a shaped object with increased accuracy. However, the thickened substrate 10 is not only costly and but also heavyweight, consequently reducing the efficiency of works such as a substrate replacement work and the like.

### SUMMARY OF THE INVENTION

In view of the above, the present invention provides a method for producing a three-dimensionally shaped object, which is capable of suppressing warpage of the shaped object and producing the shaped object with increased accuracy and which assists in saving cost and enhancing the efficiency of works such as a substrate replacement work and the like.

In accordance with an aspect of the present invention, there is provided a method for producing a three-dimensionally shaped object, including: a powder layer forming step of supplying a powdery material to form a powder layer; a solidified layer forming step of irradiating a light beam on a specified portion of the powder layer to sinter or melt the powder layer into a solidified layer; and a step of repeating the powder layer forming step and the solidified layer forming step to integrally laminate the solidified layer to produce the three-dimensionally shaped object, wherein the solidified layer is integrally formed on an upper surface of a substrate and the thickness of the substrate is decided by a maximum horizontal cross-sectional area of the shaped object.

With such configuration, the thickness of the substrate is decided by the maximum horizontal cross-sectional area of the shaped object integrally formed on the substrate. This makes it possible to produce a shaped object with increased accuracy by suppressing warpage of the shaped object which may occur depending on the horizontal cross-sectional area of the shaped object. In addition, this assists in saving cost and making the substrate lightweight, which makes it possible to enhance the efficiency of works such as a substrate replacement work and the like.

Preferably, the substrate is made of a material having the Young's modulus greater than that of the shaped object.

With such configuration, it is possible to produce a shaped object with increased accuracy by suppressing warpage of the shaped object. This is because the Young's modulus of the substrate is greater than that of the shaped object. The warpage of the shaped object is caused by the contraction stress thereof. The Young's modulus denotes a constant indicating the warpage resistance against the contraction stress.

The substrate may be fixed to a substrate mounting table by means of a bolt and the diameter of the bolt may be decided by the thickness of the substrate or the maximum horizontal cross-sectional area of the shaped object.

With such configuration, the diameter of the bolt used in fixing the substrate to the substrate mounting table is decided by the maximum horizontal cross-sectional area of the shaped object formed on the substrate or the thickness of the substrate. This makes it possible to suppress warpage of the substrate and, eventually, warpage of the shaped object, which may occur depending on the horizontal cross-sectional area of the shaped object and the length of the bolt decided by the thickness of the substrate. Thanks to this feature, it becomes possible to produce a shaped object with increased accuracy.

### BRIEF DESCRIPTION OF THE DRAWINGS

FIG. 1 is a perspective view showing an optical metal shaping machine in accordance with one embodiment of the present invention.

FIGS. 2A through 2C are section views illustrating the movement of individual parts of the shaping machine in the process of producing a shaped object.

FIG. 3 is a flowchart representing the sequence of a shaping process performed by the shaping machine.

FIGS. 4A through 4E are perspective views illustrating the object shaping process performed by the shaping machine.

FIG. 5 is a section view for explaining how to measure the warpage amount of the shaped object.

FIG. 6 is a graph representing the relationship between the number of solidified layers laminated in the shaped object and the warpage amount of the shaped object.

FIG. 7 is a graph representing the relationship between the thickness of the shaping plate and the warpage amount of the shaped object.

FIG. 8 is a graph representing the relationship between the thickness of the shaping plate used in the production of the shaped object and the maximum cross-sectional area of the shaped object.

FIG. 9 is a perspective view showing the shaping plate and the elevator table.

FIG. 10 is a graph representing the relationship between the diameter of the bolt used in the production of the shaped object and the warpage amount of the shaped object.

FIG. 11 is a plan view showing the elevator table.

FIG. 12 is a view depicting a warpage phenomenon that may occur in the shaped object.

### DETAILED DESCRIPTION OF THE PREFERRED EMBODIMENTS

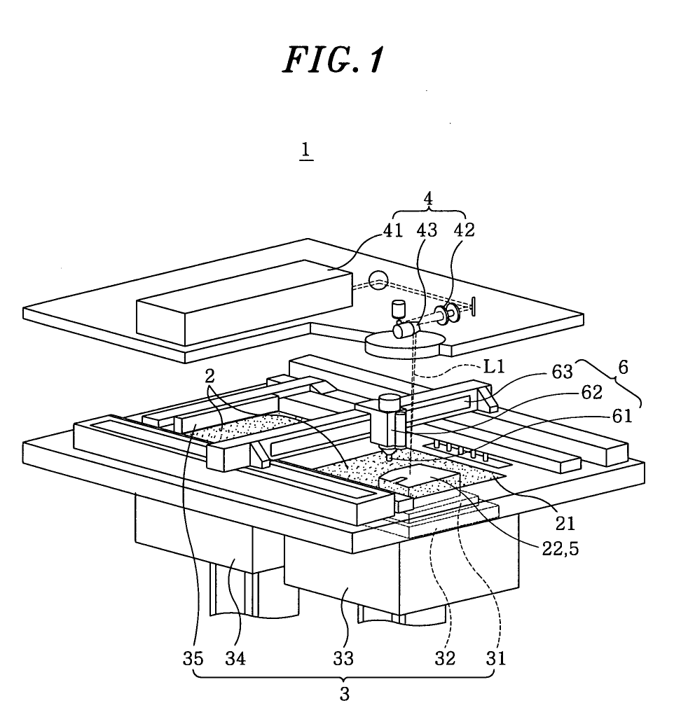

A method for producing a three-dimensionally shaped object in accordance with one embodiment of the present invention will now be described with reference to FIGS. 1 through 11. FIG. 1 shows an optical metal shaping machine (hereinafter simply referred to as an optical shaping machine) used in the present production method.

The optical shaping machine 1 includes a powder layer forming unit 3 for feeding a metallic powder 2 (powdery material) and forming a powder layer 21, a solidified layer forming unit 4 for irradiating a light beam L on a specified portion of the powder layer 21 to sinter or melt (hereinafter simply referred to as sintering) the powder layer 21 into a solidified layer 22, and a cutting and removing unit 6 for cutting a three-dimensionally shaped object 5 (hereinafter simply referred to as a shaped object 5) formed of the solidified layers 22 laminated one above another. The metallic powder 2 may be, e.g., a spherical iron powder having an average particle size of 20 μm.

The powder layer forming unit 3 includes a substrate 31 on which the powder layer 21 of the metallic powder 2 is placed, an elevator table 32 (or a substrate mounting table) for holding the substrate 31 and moving the same up and down, and a shaping tank 33 for accommodating the substrate 31 and the elevator table 32. The powder layer forming unit 3 further includes a powder tank 34 for storing the metallic powder 2 and pushing the same upwards, and a powder supply blade 35 for spreading the metallic powder 2 on the substrate 31 to form the powder layer 21. The substrate 31 is made of carbon steel such as S55C or the like.

The solidified layer forming unit 4 includes a light beam oscillator 41 for emitting a light beam L, a collecting lens 42 for collecting the light beam L thus emitted and a galvano-mirror 31 for scanning the collected light beam L on the powder layer 21. The light beam L may be, e.g., a CO₂ laser beam or an Nd-YAG laser beam, and the output power of the light beam L may be, e.g., about 500 W. The cutting and removing unit 6 includes a cutting tool 61 for cutting the shaped object 5, a milling head 62 for holding the cutting tool 61 and an XY drive unit 63 for moving the milling head 62.

The optical shaping machine 1 further includes a control unit (not shown) for controlling the operation of individual parts thereof. The control unit controls the irradiation route of the light beam L and the moving route of the cutting tool 61 based on the three-dimensional CAD data of the shaped object 5. The irradiation route is set based on the contour data of the respective cross-sections obtained by slicing, at an equal pitch of, e.g., about 0.05 mm, the STL (Stereo Lithography) preliminarily generated from the three-dimensional CAD data of the shaped object 5. The irradiation route is preferably set to ensure that the outermost surface of the shaped object 5 has high density with the porosity of 5% or less.

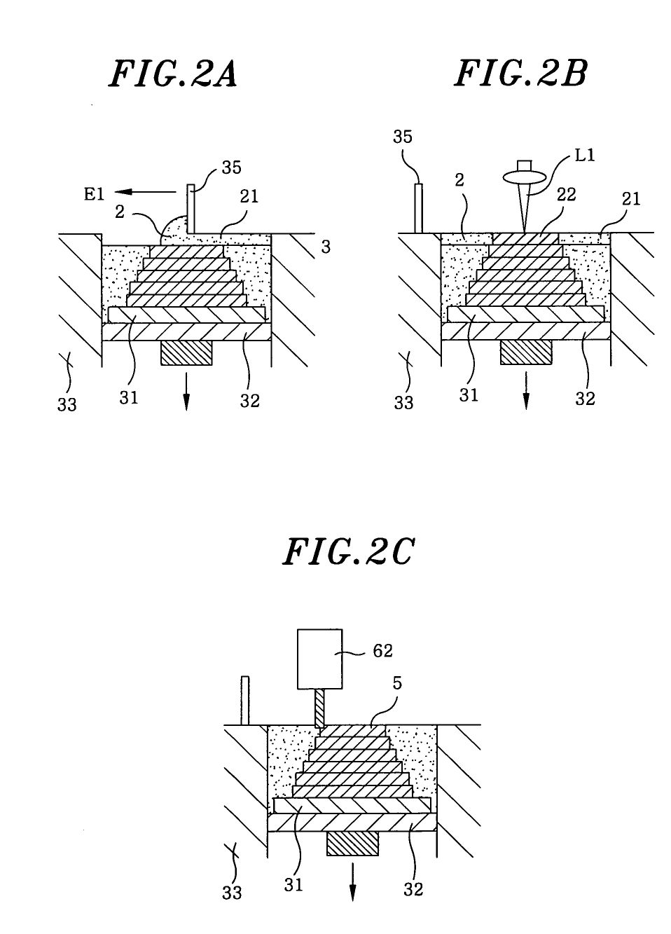

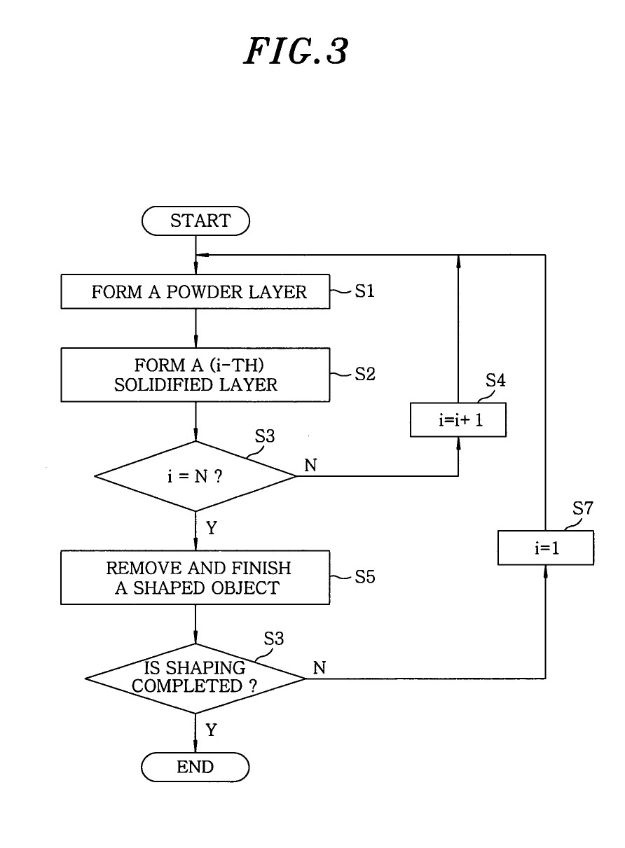

FIGS. 2A through 2C show the shaping operation of the optical shaping machine 1. As shown in FIG. 2A, the elevator table 32 is moved down and then the powder supply blade 35 is moved in the plane direction of the substrate 31 (namely, in the direction indicated by an arrow E1), thereby supplying the metallic powder 2 onto the substrate 31 and leveling the same. In this way, a powder layer 21 is formed. This step corresponds to the powder layer forming step (S1) illustrated in FIG. 3.

Next, the orientation of a mirror surface of the galvano-mirror 43 (see FIG. 1) is controlled so that the light beam L can be scanned on a specified portion of the powder layer 21 as shown in FIG. 2B. Thus, the metallic powder 2 is sintered into a solidified layer 22. This step corresponds to the solidified layer forming step (S2) illustrated in FIG. 3. The i-th solidified layer is formed in this way, wherein the “i” is an integer.

The powder layer forming step shown in FIG. 2A and the solidified layer forming step shown in FIG. 2B are repeatedly performed to laminate a plurality of solidified layers 22 one above another. Lamination of the solidified layers 22 is repeated until the layer number i grows equal to a target layer number N (steps S1 through S4 in FIG. 3).

If the layer number i of the solidified layers 22 reaches the target layer number N, the milling head 61 is moved by the XY drive unit 63 (see FIG. 1) as shown in FIG. 2C. Then the unnecessary portion of the surface of the shaped object 5 is removed by the cutting tool 61, thereby making the surface of the shaped object 5 smooth. This step corresponds to the removing and finishing step (S5) illustrated in FIG. 3. Thereafter, the operation is returned back to the process shown in FIG. 2A. At the end of the step S5 illustrated in FIG. 3, determination is made as to whether the shaping operation has been completed (S6). If not (if the answer is No in the step S6), the layer number i is initialized (S7) and the flow returns back to the step S1. In this way, the formation of the solidified layer 22 and the removal of the unnecessary portion of the surface of the shaped object 5 are repeated until the shaping operation comes to an end (until the answer is Yes in the step S6).

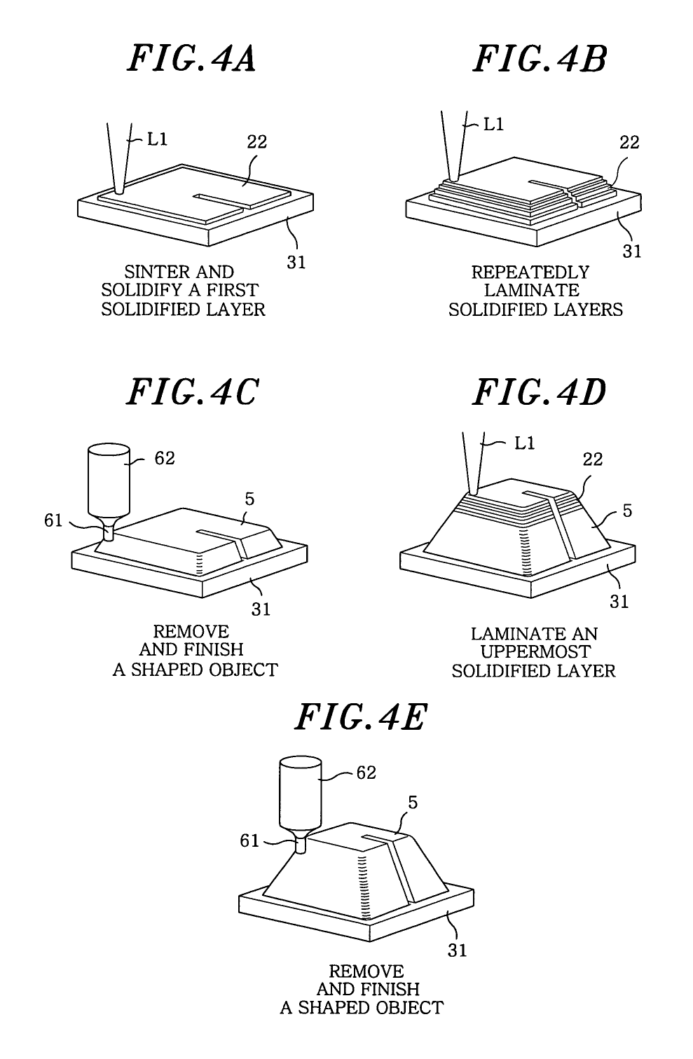

FIGS. 4A through 4E illustrate different production steps performed until the shaped object 5 is finally produced. As shown in FIG. 4A, a first solidified layer 22 is formed on the substrate 31 by the irradiation of the light beam L. During the sintering and solidifying process, the first solidified layer 22 is bonded to and integrally formed with the upper surface of the substrate 31. Thereafter, additional solidified layers are laminated on the first solidified layer 22 as illustrated in FIG. 4B. If the number of the solidified layers thus laminated becomes equal to the target layer number N, the unnecessary portion of the surface of the shaped object 5 is removed by the cutting tool 61 as illustrated in FIG. 4C. The lamination of the solidified layers and the removal of the unnecessary portion are repeated. At last, the uppermost solidified layer is laminated as illustrated in FIG. 4D and the unnecessary portion of the surface of the shaped object 5 is removed as illustrated in FIG. 4E.

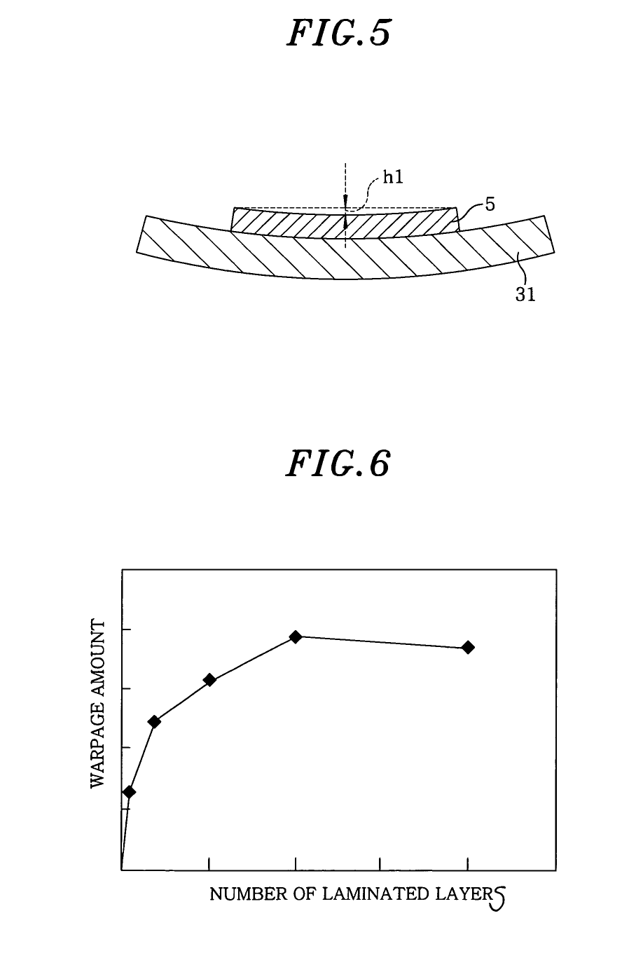

During the production process of the shaped object 5, a contraction stress is generated in the shaped object 5 as the sintering and solidifying operation proceeds. As a consequence, the peripheral portion of the shaped object 5 is warped upwards by the upward bending moment. The warpage amount varies with the horizontal cross-sectional area (hereinafter simply referred to as cross-sectional area) of the shaped object 5 and the number of the solidified layers laminated. In this regard, it is assumed that, as shown in FIG. 5, the warpage amount denotes the difference in height hi between the opposite side edges and the center of the upper surface of the shaped object 5.

As the cross-sectional area of the shaped object 5 increases, the force acting to cause warpage in the shaped object 5, i.e., the so-called bending moment, becomes greater, so that the warpage amount of the shaped object 5 is increased. As represented in FIG. 6, the warpage amount is also increased in the event that the number of the solidified layers laminated becomes greater. However, the warpage amount shows little change if the number of the solidified layers laminated becomes equal to or greater than a predetermined value.

In the present embodiment, only the cross-sectional area of the shaped object 5 is taken into account and the thickness of the substrate 31 to suppress warpage of the shaped object 5 is decided by the maximum cross-sectional area of the shaped object 5.

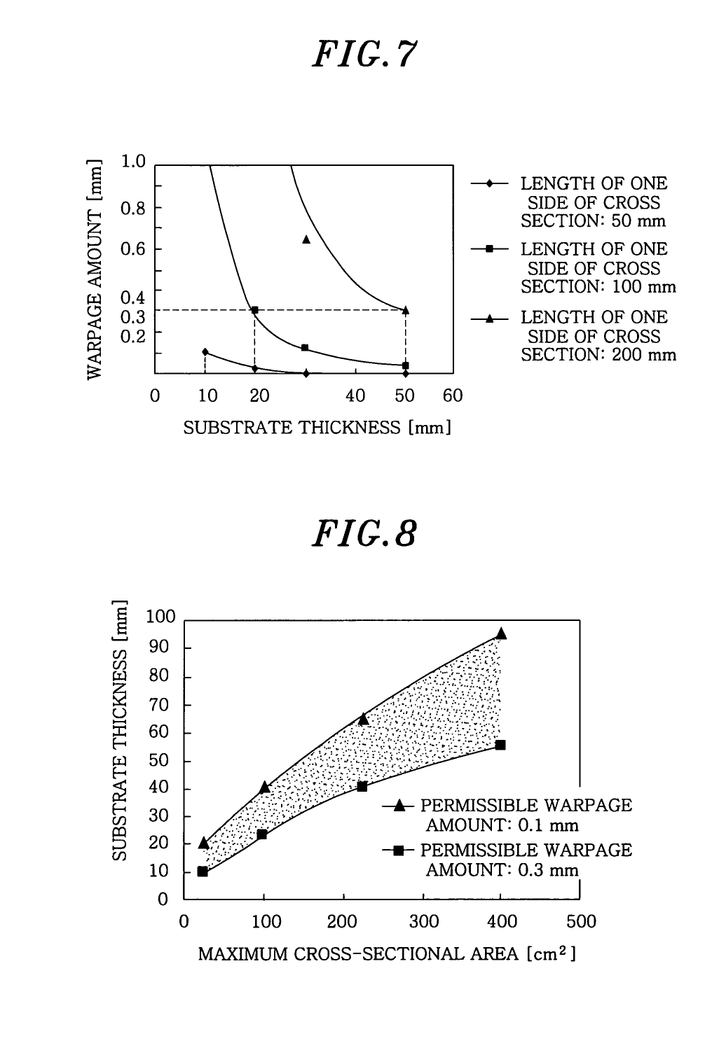

In this connection, FIG. 7 represents the change in warpage amount of the shaped object when the thickness of the substrate is changed. In FIG. 7, the cross section of the shaped object is assumed to be square and the length of one side of the cross section is used as a parameter. The warpage amount refers to the maximum value available when the number of the solidified layers laminated is changed. As can be seen in FIG. 7, the warpage amount of the shaped object is decreased as the thickness of the substrate becomes greater. In order to keep the warpage amount of the shaped object at a specified value regardless of the numerical value of the parameter even when the parameter is changed, there is a need to increase the thickness of the substrate in keeping with the increase in the numerical value of the parameter. For example, in case where the parameter is set to about 50 mm, 100 mm and 200 mm, the thickness of the substrate 31 needs to be at least about 10 mm, 20 mm and 50 mm, respectively, in order to keep the warpage amount at about 0.3 mm or less.

For the reasons stated above, the thickness of the substrate 31 in the present embodiment is increased as the maximum cross-sectional area of the shaped object 5 becomes greater. The relationship between the maximum cross-sectional area of the shaped object 5 and the thickness of the substrate 31 may be set as shown in Table 1 and FIG. 8. Table 1 shows the relationship between the length of one side of the maximum cross section of the shaped object 5 having a generally square shape, the maximum cross-sectional area of the shaped object 5, and the thickness of the substrate 31. In Table 1, the maximum cross-sectional area refers to the value available when the permissible warpage amount of the shaped object 5 is set equal to about 0.3 mm.

TABLE 1

| Length of one side of | Maximum cross- | Substrate |
|---|---|---|
| maximum cross section of | sectional area | thickness |
| shaped object (mm) | (cm²) | (mm) |
| 200 | 400 | 50 |
| 150 | 225 | 35 |
| 100 | 100 | 20 |
| 50 | 25 | 10 |

FIG. 8 shows the relationship between the maximum cross-sectional area of the shaped object 5 and the thickness of the substrate 31 when the maximum cross-sectional area is in the range of from about 25 to 400 cm². In FIG. 8, there are shown two curves indicating the relationship when the permissible warpage amount is approximately 0.1 mm and 0.3 mm. In case where the permissible warpage amount is in the range of from about 0.1 to 0.3 mm, the thickness of the substrate 31 corresponding to the maximum cross-sectional area is set to fall within the dotted region between the two curves. It is preferred that the thickness of the substrate 31 is at least about 10 mm.

Next, description will be made on the material of the substrate 31. The substrate 31 is made of a rigid material having the Young's modulus greater than that of the shaped object 5. If the shaped object 5 is produced by sintering an iron powder, the Young's modulus thereof is about 100 to 150 MPa. In this case, the substrate 31 is made of, e.g., pre-hardened steel (having the Young's modulus of about 210 GPa), high speed steel called HSS (having the Young's modulus of about 240 GPa), tungsten carbide (having the Young's modulus of about 400 to 500 GPa) or alumina ceramic (having the Young's modulus of about 300 to 400 GPa), all of which have the Young's modulus greater than that of the shaped object 5.

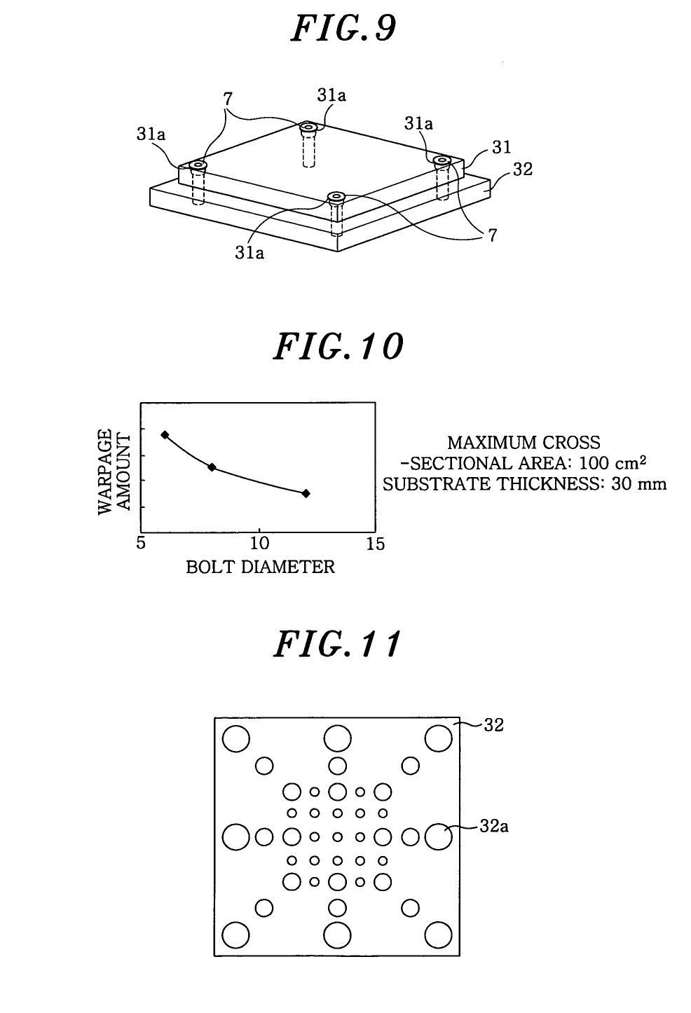

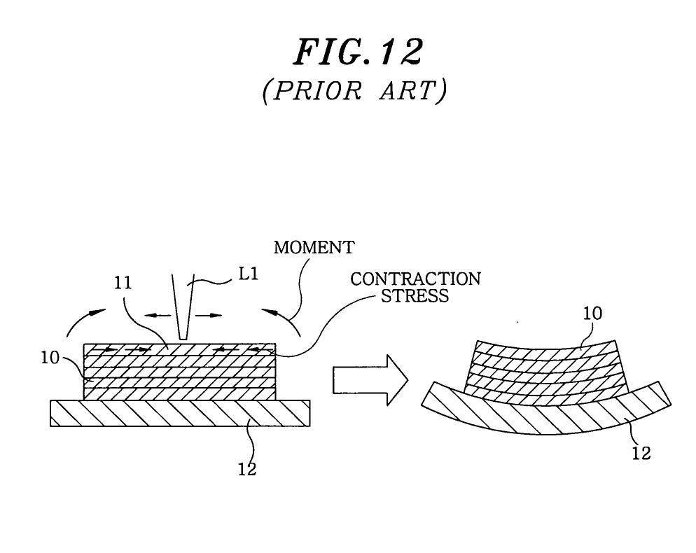

Next, a method of fixing the substrate 31 to the elevator table 32 will be described with reference to FIG. 9 which shows the outward appearance of the substrate 31 and the elevator table 32. The substrate 31 is fixed to the upper surface of the elevator table 32 by bolts 7 inserted into holes 31a formed in the four corners of the substrate 31. As mentioned earlier, the shaped object 5 exercises a greater force to warp the substrate 31 as the cross-sectional area thereof increases. The thickness of the substrate 31 is increased in proportion to the cross-sectional area of the shaped object 5 in order to suppress warpage of the shaped object 5. This makes it necessary to increase the length of the bolts 7 in proportion to the thickness of the substrate 31. If the length of the bolts 7 is increased, however, the total elongation amount relative to the tensile stress becomes greater. This may possibly lead to an increase in the warpage amount of the substrate 31. For that reason, the diameter of the bolts 7 in the present embodiment is decided by the thickness of the substrate 31 or the maximum cross-sectional area of the shaped object 5. More specifically, as shown in FIG. 10, the warpage amount of the shaped object 5 is reduced if the diameter of the bolts 7 gets greater. In view of this, the diameter of the bolts 7 is set to become greater in proportion to the thickness of the substrate 31 and the maximum cross-sectional area of the shaped object 5. It is preferred that the uppermost portion of each of the bolts 7 is positioned below the upper surface of the substrate 31 when the substrate 31 is fixed to the elevator table 32.

Next, the elevator table 32 will be described with reference to FIG. 11 which shows the outward appearance of the elevator table 32. The elevator table 32 is provided with thread holes 32a into which the bolts 7 are threadedly fitted. The thread holes 32a are arranged in alignment with the holes of the substrate 31 and formed in different sizes so that they can cope with the change in the size of the substrate 31. The diameter of the thread holes 32a is set in conformity with the diameter of the bolts 7 so that the diameter of the thread holes 32a remains small near the center of the elevator table 32 but becomes greater toward the peripheral edge of the elevator table 32.

As described above, the thickness of the substrate 31 in the present embodiment is decided by the maximum cross-sectional area of the shaped object 5 integrally formed on the substrate 31. This suppresses warpage of the substrate 31 which would be generated in the shaping process depending on the cross-sectional area of the shaped object 5. As a result, it becomes possible to produce the shaped object 5 with increased accuracy and also to save cost. In addition, the substrate 31 is made lightweight, which makes it possible to enhance the efficiency of works such as a replacement work of the substrate 31 and the like. Thus, it becomes easy to perform what is called handling of the substrate 31. Since the moving range of the elevator table 32 is decided in advance, it is possible to produce a shaped object with increased height.

The warpage of the shaped object 5 is caused by the contraction stress thereof. The Young's modulus denotes a constant indicating the warpage resistance against the contraction stress. Since the Young's modulus of the substrate 31 is greater than that of the shaped object 5, it is possible to suppress warpage of the shaped object 5 and to produce the shaped object 5 with increased accuracy.

The diameter of the bolts 7 used in fixing the substrate 31 to the elevator table 32 is decided by the maximum cross-sectional area of the shaped object 5 formed on the substrate 31 or the thickness of the substrate 31. This makes it possible to suppress warpage of the substrate 31 and, eventually, warpage of the shaped object 5, which may occur depending on the horizontal cross-sectional area of the shaped object 5 and the length of the bolts 7 decided by the thickness of the substrate 31. Thanks to this feature, it becomes possible to produce a shaped object 5 with increased accuracy.

The cutting and removing unit 6 is preferably a general-purpose numerical control machine tool, which includes the cutting tool 61, the milling head 62 and the XY drive unit 63, and more preferably a machining center capable of automatically replacing the cutting tool 61 with another one. A dual blade ball end mill made of a super-hard material is mainly used as the cutting tool 61. Depending on the shape to be machined or the purpose of machining, it may be possible to use a square end mill, a radius end mill, a drill and so forth.

The present invention shall not be limited to the foregoing embodiments but may be modified in many different forms depending on the purpose of use. For example, the powdery material is not limited to the metallic powder 2 but may be an inorganic material such as ceramic or the like or an organic material such as plastics or the like. The light beam L may be transmitted through the air or via an optical fiber. The removing and finishing step illustrated in FIG. 2C may be omitted from the production flow of the shaped object 5. In this case, the optical shaping machine 1 may not include the cutting and removing unit 6.

What is claimed is:

1. A method for producing a three-dimensionally shaped object, comprising:
a powder layer forming step of supplying a powdery material to form a powder layer;
a solidified layer forming step of irradiating a light beam on a specified portion of the powder layer to sinter or melt the powder layer into a solidified layer; and
a step of repeating the powder layer forming step and the solidified layer forming step to integrally laminate the solidified layer to produce the three-dimensionally shaped object,
wherein the solidified layer is integrally formed on an upper surface of a substrate and the thickness of the substrate is decided by a maximum horizontal cross-sectional area of the shaped object.

2. The method of claim 1, wherein the substrate is made of a material having the Young's modulus greater than that of the shaped object.

3. The method of claim 1, wherein the substrate is fixed to a substrate mounting table by means of a bolt and the diameter of the bolt is decided by the thickness of the substrate or the maximum horizontal cross-sectional area of the shaped object.

4. The method of claim 2, wherein the substrate is fixed to a substrate mounting table by means of a bolt and the diameter of the bolt is decided by the thickness of the substrate or the maximum horizontal cross-sectional area of the shaped object.
